(19) United States
(12) Patent Application Publication
(10) Pub. No.: US 2026/0196954 A1
(43) Pub. Date: Jul. 9, 2026

(54) MOTOR CONTROL DEVICE AND POWER CONVERSION SYSTEM

(71) Applicant: Astemo, Ltd., Chiyoda-ku, Tokyo (JP)

(72) Inventors: Shigehisa AOYAGI, Hitachinaka-shi, lbaraki (JP); Takaya TSUKAGOSHI, Hitachinaka-shi, lbaraki (JP)

(73) Assignee: Astemo, Ltd., Chiyoda-ku, Tokyo (JP)

(21) Appl. No.: 19/132,725

(22) PCT Filed: Nov. 28, 2022
(86) PCT No.: PCT/JP2022/043754

§ 371 Date: May 23, 2025

(51) Int. Cl. H02P 21/09; H02P 21/18; H02P 21/22; H02P 27/12

(52) U.S. Cl. CPC H02P 21/09; H02P 21/18; H02P 21/22; H02P 27/12

(57) ABSTRACT

Provided is a motor control device capable of reducing a loss by controlling a current phase angle based on a change feature of inductance. A motor control device is connected to a power converter that performs power conversion from DC power to three-phase AC power and drives a motor with the three-phase AC power to control the power conversion of the power converter. The motor control device includes: an inductance change detection unit configured to calculate an inductance change feature indicating a change in inductance of the motor in a first phase region including a phase at which an absolute value of one of three-phase AC currents is a maximum; and a current phase angle control unit configured to control a current phase angle based on the inductance change feature.

### TECHNICAL FIELD

The present invention relates to a motor control device and a power conversion system.

### BACKGROUND ART

Motor control devices determine three-phase AC voltage commands that satisfy torque commands or the like and that reduce losses (copper losses and iron losses) in three-phase synchronous motors, and control inverters based on the three-phase AC voltage commands.

PTL 1 discloses a technique for suppressing such a loss. As disclosed in PTL 1, “the carrier wave frequency adjustment unit adjusts a phase difference between the voltage command and the carrier wave to reduce an eddy current loss occurring in a magnet of a rotor of the AC motor in accordance with a d-axis current applied to the AC motor and a rotational speed of the AC motor.” in claim 1, “an eddy current loss We is indicated by a proportional relationship expressed by the following Formula (11).” in Paragraph 0061, “Formula (11) can be expressed by being replaced with the proportional relationship expressed in Formula (12) below.” in paragraph 0063, and “the fixed triangular wave phase determination unit 1633 determines a value of the carrier wave phase difference Δθcarr based on the d-axis current sum sum calculated by the d-axis current sum calculation unit 1632. Here, the value of the carrier wave phase difference Δθcarr is determined such that the value of the d-axis current sum sum is a minimum” in paragraph 0072.

As disclosed in PTL 1, in paragraph 0076, “the voltage phase error calculation unit 163 determines the carrier wave phase difference Δθcarr and calculates the voltage phase error Δθv, as described above. Accordingly, the voltage phase error Δθv can be determined such that the d-axis current sum sum is a minimum in accordance with the d-axis current Id and the motor rotational speed or. As a result, the carrier wave frequency fc can be set by changing the phase difference between the voltage command for the inverter 3 and the carrier wave used for pulse width modulation to reduce the eddy current loss occurring in the magnet of the rotor of the motor 2. As a result, an increase in the magnet temperature Tmag can be suppressed, and occurrence of irreversible demagnetization can be prevented”.

### CITATION LIST

### Patent Literature

PTL 1: JP 2022-18168 A

### SUMMARY OF INVENTION

### Technical Problem

However, an iron loss such as eddy current loss depends on a magnetic flux generated in a coil, and this magnetic flux can be reduced by increasing the d-axis current. Therefore, the iron loss may be suppressed when the d-axis current is not a minimum. Accordingly, there is a problem that the d-axis current needs to be appropriately selected in order to minimize the loss.

In addition, since the iron loss also varies depending on the inductance, there is a problem that it is necessary to detect a change in the inductance and control the current according to the change in the inductance in order to suppress the loss.

Therefore, an object of the present invention is to provide a motor control device and a power conversion system capable of reducing a loss by controlling a current phase angle based on a change feature of inductance.

### Solution to Problem

In order to solve the above problem, a motor control device according to the present invention is a motor control device connected to a power converter that performs power conversion from DC power to three-phase AC power and drives a motor with the three-phase AC power to control the power conversion of the power converter. The motor control device includes: an inductance change detection unit configured to calculate an inductance change feature indicating a change in inductance of the motor in a first phase region including a phase at which an absolute value of one of three-phase AC currents is a maximum; and a current phase angle control unit configured to control a current phase angle based on the inductance change feature.

A power conversion system according to the present invention includes, for example, the motor control device and the power converter.

### Advantageous Effects of Invention

According to the present invention, it is possible to provide a motor control device and a power conversion system capable of reducing a loss by controlling a current phase angle based on a change feature of inductance.

### BRIEF DESCRIPTION OF DRAWINGS

FIG. 1 is an overall configuration diagram of a motor drive system including a motor control device.

FIG. 2 is a block diagram illustrating a functional configuration of a motor control device according to an embodiment.

FIG. 3 is a diagram illustrating a sampling period of an average value of a current.

FIG. 4 is a diagram illustrating a sampling period of the average value of the current.

FIG. 5 is a diagram illustrating an example of a relationship between a current I flowing in a coil and a magnetic flux Φ generated in the coil.

FIG. 6 is a diagram illustrating a sampling period of a current used for calculating an inductance change feature.

FIG. 7 is a diagram illustrating a sampling period of a current used for calculating an inductance change feature.

FIG. 8 is a diagram illustrating a relationship between a carrier wave frequency and a current ripple.

FIG. 9 is a diagram illustrating a relationship between a three-phase AC current and a carrier wave frequency.

FIG. 10 is a diagram illustrating a relationship between a loss and a current phase angle.

### DESCRIPTION OF EMBODIMENTS

Hereinafter, the present invention will be described in detail with reference to the drawings. The present invention is not limited to embodiments described below. The embodiments are merely exemplary, and the present invention can be implemented in various modified and improved forms based on the knowledge of those skilled in the art. In the drawings used in the following description, common devices and operations are denoted by the same reference numerals, and the description of the devices, apparatuses, and operations to be described above may be omitted.

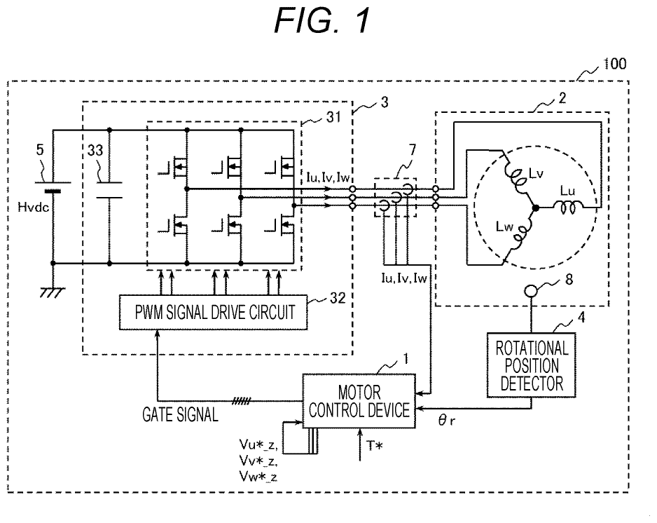

FIG. 1 is an overall configuration diagram of a motor drive system including a motor control device. In FIG. 1, a motor drive system 100 according to the embodiment includes a motor control device 1, a motor 2, an inverter (power converter) 3, a rotational position detector 4, a high-voltage battery 5, a current detection unit 7, and a rotational position sensor 8.

A rotational position Or of the motor 2 is input from the rotational position detector 4 to the motor control device 1. Iu, Iv, and Iw denoting three-phase AC currents flowing in the motor 2 are input from the current detection unit 7, and a torque command T* is input from a host control device (not illustrated). The motor control device generates a gate signal for controlling drive of the motor 2 based on input information, and outputs the gate signal to the inverter 3. Accordingly, an operation of the inverter 3 is controlled, and the drive of the motor 2 is controlled. Details of the motor control device 1 will be described below.

The inverter 3 includes an inverter circuit 31, a PWM signal drive circuit 32, and a smoothing capacitor 33. The PWM signal drive circuit 32 generates a PWM signal for controlling each switching element included in the inverter circuit 31 based on the gate signal input from the motor control device 1, and outputs the generated PWM signal to the inverter circuit 31. The inverter circuit 31 includes switching elements respectively corresponding to upper and lower arms of the U phase, the V phase, and the W phase. By controlling each of these switching elements in accordance with the PWM signal input from the PWM signal drive circuit 32, the DC power supplied from the high-voltage battery 5 is converted into AC power to be output to the motor 2. The smoothing capacitor 33 smooths the DC power supplied from the high-voltage battery 5 to the inverter circuit 31.

The high-voltage battery 5 is a DC voltage source of the motor drive system 100, and outputs a power supply voltage Hvdc to the inverter 3. The power supply voltage Hvdc of the high-voltage battery 5 is converted into a pulsed three-phase AC voltage having a variable voltage and a variable frequency by the inverter circuit 31 and the PWM signal drive circuit 32 of the inverter 3 to be applied to the motor 2 as a line voltage. Accordingly, AC power is supplied from the inverter 3 to the motor 2 based on the DC power of the high-voltage battery 5. The power supply voltage Hvdc of the high-voltage battery 5 varies in accordance with a charge state of the high-voltage battery 5.

The motor 2 is a three-phase motor rotationally driven by AC power supplied from the inverter 3, and includes a stator and a rotor. In the embodiment, an example in which a permanent magnet synchronous motor is used as the motor 2 will be described, but the present invention is not limited thereto. When the AC power input from the inverter 3 is applied to the three-phase coils Lu, Lv, and Lw provided in the stator, three-phase AC currents Iu, Iv, and Iw are electrified in the motor 2, and thus a magnetic flux is generated in each coil. When an attractive force and a repulsive force are generated between the magnetic flux of each coil and the magnetic flux of the permanent magnet disposed in the rotor, torque is generated in the rotor, and the motor 2 is rotationally driven.

The rotational position sensor 8 that detects a rotational position Or of the rotor is fitted in the motor 2. The rotational position detector 4 calculates a rotational position Or from an input signal of the rotational position sensor 8. A calculation result of the rotational position Or by the rotational position detector 4 is input to the motor control device 1, and is used for phase control of the AC power performed by the motor control device 1 generating a pulsed gate signal in accordance with a phase of an induced voltage of the motor 2.

Here, a resolver including an iron core and a winding is more appropriate as the rotational position sensor 8, but there is no problem even if a magnetoresistive element such as a giant magneto resistive effect (GMR) sensor or a sensor using a Hall element is applied. Any sensor can be used as the rotational position sensor 8 as long as a magnetic pole position of the rotor can be measured. The rotational position detector 4 may estimate the rotational position Or using the three-phase AC currents Iu, Iv, and Iw flowing in the motor 2 and the three-phase AC voltages Vu, Vv, and Vw applied from the inverter 3 to the motor 2 without using the input signal from the rotational position sensor 8.

The current detection unit 7 is disposed in a current path between the inverter 3 and the motor 2. The current detection unit 7 detects three-phase AC currents Iu, Iv, and Iw (the U-phase AC current Iu, the V-phase AC current Iv, and the W-phase AC current Iw) that electrify the motor 2. For the current detection unit 7, for example, a Hall current sensor or the like can be used. Detection results of the three-phase AC currents Iu, Iv, and Iw by the current detection unit 7 are input to the motor control device 1 and are used for generating a gate signal performed by the motor control device 1. Although FIG. 1 illustrates an example in which the current detection unit 7 includes three current detectors, two current detectors may be provided, and an AC current of the remaining one phase may be calculated from the fact that the sum of the three-phase AC currents Iu, Iv, and Iw is zero. The pulsed direct current flowing from the high-voltage battery 5 into the inverter 3 may be detected by a shunt resistor or the like inserted between the smoothing capacitor 33 and the inverter 3, and the three-phase AC currents Iu, Iv, and Iw may be obtained based on the direct current and the three-phase AC current voltages Vu, Vv, and Vw applied from the inverter 3 to the motor 2.

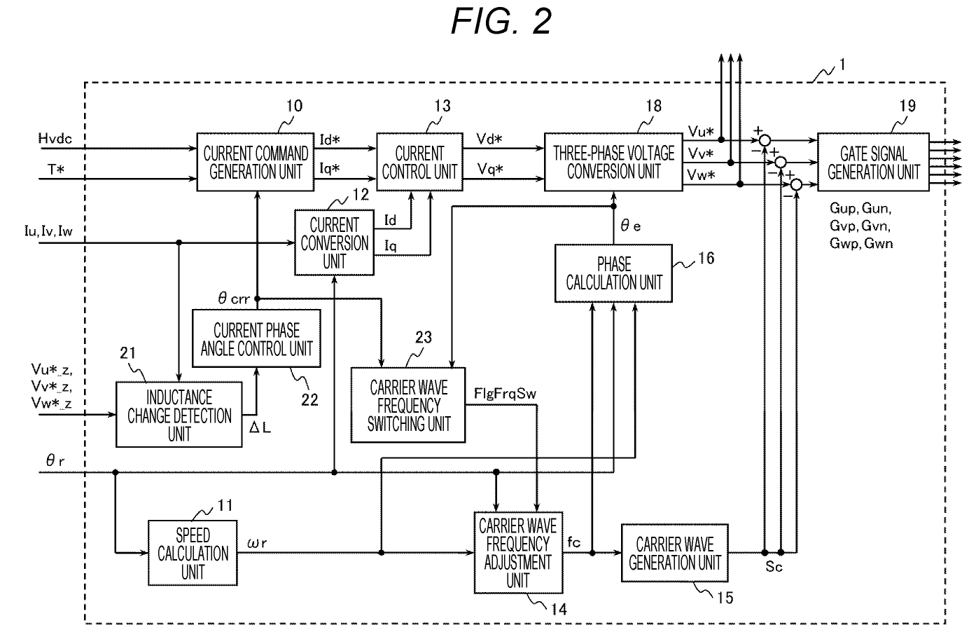

Next, details of the motor control device 1 will be described. FIG. 2 is a block diagram illustrating a functional configuration of the motor control device 1 according to the embodiment.

The motor control device 1 includes functional blocks of a current command generation unit 10, a speed calculation unit 11, a current conversion unit 12, a current control unit 13, a carrier wave frequency adjustment unit 14, a carrier wave generation unit 15, a phase calculation unit 16, a three-phase voltage conversion unit 18, a gate signal generation unit 19, an inductance change detection unit 21, a current phase angle control unit 22, and a carrier wave frequency switching unit 23. Here, the current command generation unit 10, the current conversion unit 12, the current control unit 13, and the three-phase voltage conversion unit 18 function as a three-phase AC voltage command generation unit. A configuration of the three-phase AC voltage command generation unit is not limited thereto and may include another function. The motor control device 1 includes, for example, a microcomputer, and can implement these functional blocks by executing a predetermined program in the microcomputer. Alternatively, some or all of the functional blocks may be realized using a hardware circuit such as a logic IC or a field programmable gate array (FPGA).

The speed calculation unit 11 calculates a motor rotational speed or indicating a rotational speed (rotational speed) of the motor 2 from a temporal change of the rotational position Or of the motor 2. The motor rotational speed or may be a value indicated by either an angular speed (rad/s) or a rotational speed (rpm). The values may be mutually converted and used.

The carrier wave frequency adjustment unit 14 determines a carrier wave frequency fc indicating a frequency of the carrier wave used to generate a gate signal based on the rotational speed or obtained by the speed calculation unit 11. For example, the carrier wave frequency fc is determined so that the number Nc of synchronous PWM carrier waves indicating the number of carrier waves for one cycle of a voltage waveform in the synchronous PWM control is a predetermined integer. Here, the number Nc of synchronous PWM carrier waves can be set as, for example, a number that satisfies a conditional formula of Nc=3×(2×n−1) among multiples of 3. In this conditional formula, n indicates any natural number. For example, n=1 (Nc=3), n=2 (Nc=9), n=3 (Nc=15), or the like can be selected. The number Nc of synchronous PWM carrier waves can also be changed in accordance with the rotational speed or. Then, the carrier wave frequency adjustment unit 14 determines fc based on the rotational speed or and the number Nc of synchronous PWM carrier waves.

The carrier wave frequency adjustment unit 14 adjusts the carrier wave frequency fc in accordance with a switching flag FlgFrqSw from the carrier wave frequency switching unit 23 to be described below. For example, an example in which the carrier wave frequency adjustment unit 14 sets the carrier wave frequency fc=K·ωr·Nc/2π using a coefficient K and changes K in accordance with a value of the switching flag FlgFrqSw will be described, but the present invention is not limited thereto. If the coefficient K during the switching flag FlgFrqSw=1 is set to be larger than the coefficient K during the switching flag FlgFrqSw=0, the carrier wave frequency can be switched such that a carrier wave is a high frequency carrier wave during the switching flag FlgFrqSw=1 and a low frequency carrier wave during the switching flag FlgFrqSw=0. A method of switching the carrier wave frequency fc is not limited thereto. The carrier wave frequency adjustment unit 14 may use the rotational position Or of the motor 2 as an input so that the carrier wave frequency can be switched only when the rotational position Or of the motor 2 is within a specific range. Accordingly, the carrier wave frequency switching unit 23 performs calculation only when the rotational position Or of the motor 2 is within a specific range, and a processing load of the motor control device 1 can be reduced.

The carrier wave generation unit 15 generates a carrier wave signal Sc for each of three-phase AC voltage commands Vu*, Vv*, and Vw* based on the carrier wave frequency fc determined by the carrier wave frequency adjustment unit 14.

The phase calculation unit 16 calculates an estimated rotational position de of the motor 2 by the following Formulae (1) to (3) based on the rotational position Or, the rotational speed or, and the carrier wave frequency fc.

$$θ e = θ r + φ v \qquad ( 1 )$$

$$φ v = ω r \cdot 1.5 Tc \qquad ( 2 )$$

$$Tc = 1 / fc \qquad ( 3 )$$

Here, φv indicates a calculation delay compensation value of a voltage phase, and Tc indicates a carrier wave period. The calculation delay compensation value φv is a value that compensates for occurrence of a calculation delay corresponding to 1.5 control cycles from a time at which the rotational position detector 4 acquires the rotational position θr to a time at which the motor control device 1 outputs the gate signal to the inverter 3.

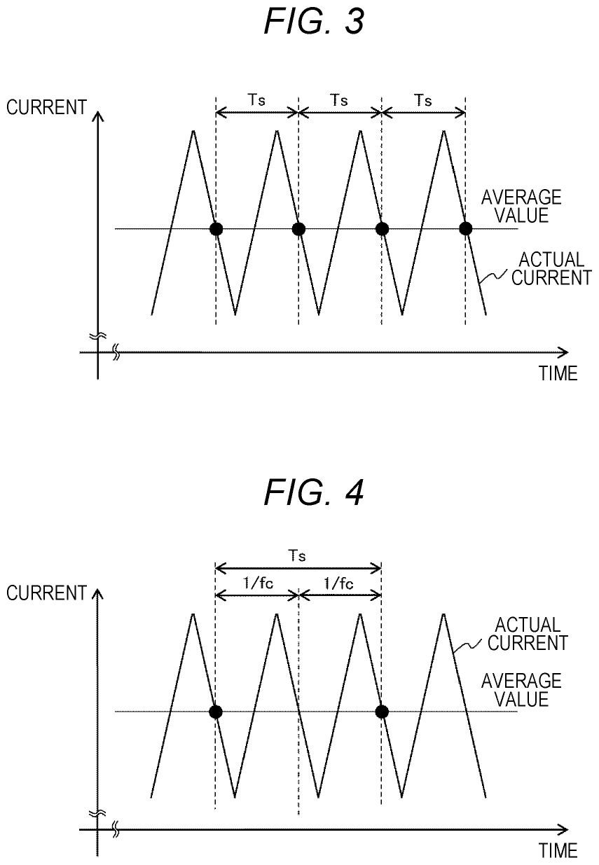

FIGS. 3 and 4 are diagrams illustrating sampling periods of average values of currents. In FIGS. 3 and 4, the vertical axis represents a current, the horizontal axis represents time, and examples of a current waveform of one phase in the three-phase AC current are illustrated. An actual current generates a current ripple and vibrates at a frequency close to the carrier wave frequency fc. To facilitate description, a frequency of the current ripple will be described below on the assumption that the frequency is equal to the carrier wave frequency fc, but the present invention is not limited thereto. As illustrated in FIG. 3, the current conversion unit 12 acquires an average value of a current for each sampling period Ts determined based on the carrier wave frequency fc, for example, Ts=1/fc. When the carrier wave frequency fc is high, the average value of the current may be acquired every integer multiple of 1/fc, for example, every Ts=2/fc as illustrated in FIG. 4. When the sampling period becomes longer, the number of times the average value is acquired becomes smaller. Therefore, a processing load of the motor control device 1 can be reduced.

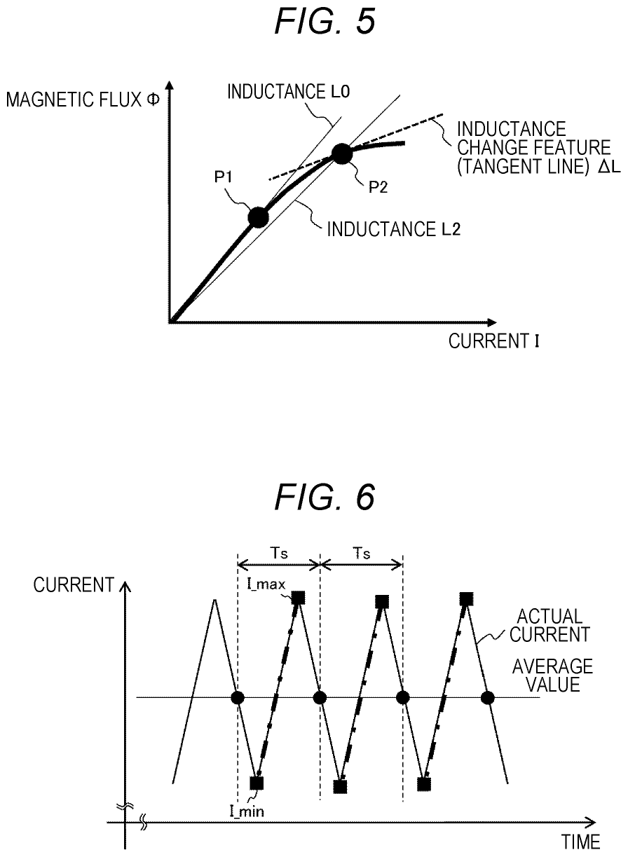

FIG. 5 is a diagram illustrating an example of a relationship between a current I flowing in a coil and a magnetic flux Φ generated in the coil. The horizontal axis represents the current I, and the vertical axis represents the magnetic flux Φ. When the current I is small, the current I and the magnetic flux Φ have a linear relationship. When the current I is large, the current I and the magnetic flux Φ have a nonlinear relationship. Hereinafter, in a curve representing the relationship between the current I and the magnetic flux Φ, a portion where the current I and the magnetic flux Φ have a linear relationship is referred to as a linear portion, and a portion where the current I and the magnetic flux Φ have a nonlinear relationship is referred to as a nonlinear portion.

The inductance L of the coil is defined by Φ=LI. Therefore, when the inductance L is calculated at each of a point P1 on the linear portion and a point P2 on the nonlinear portion, inductance L at the point P1 is an inclination L0 of a straight line connecting the origin and P1, and inductance L at the point P2 is inclination L2 of a straight line connecting the origin and P2. As described above, the inductance L takes a constant value L0 at any point on the linear portion, but the inductance L takes a value different from L0 at any point on the nonlinear portion as in the inductance L2 illustrated in FIG. 5, and varies at different points. That is, when the current I and the magnetic flux Φ have a linear relationship, the inductance L takes a constant value. When the current increases and the current I and the magnetic flux Φ have a nonlinear relationship, the inductance L changes. This is because magnetic saturation or the like occurs when the current increases. A difference between the inductance L at a point on the nonlinear portion and the inductance L0 at the linear portion increases as the current increases. In order to detect such a change in inductance from the inductance L0, it is desirable to directly calculate the inductance L from the magnetic flux Φ and the current I. However, there is a problem that it is difficult to acquire the magnetic flux Φ. Accordingly, in the embodiment, a tangent line of the curve illustrated in FIG. 5, that is, dΦ/dI is defined as an inductance change feature ΔL (=dΦ/dI), and a change in inductance from the inductance L0 is detected using the inductance change feature ΔL.

The inductance change feature ΔL at the point P1 on the linear portion matches the inductance L0 in the linear portion. Similarly, the inductance change feature ΔL is also L0 at any point on the linear portion. Accordingly, the inductance change feature ΔL at any point on the linear portion is constant at ΔL=L0. On the other hand, the inductance change feature ΔL at any point on the nonlinear portion such as the point P2 takes a value different from the inductance change feature ΔL=L0 in the linear portion, and approaches 0 as the current increases. Such a change feature of the inductance change feature ΔL, that is, a change feature in which the inductance change feature ΔL is constant at L0 in the linear portion, and deviates from the inductance change feature L0 in the linear portion as the current increases in the nonlinear portion is similar to the change feature of the inductance L. Therefore, by monitoring the inductance change feature ΔL, it is possible to detect a change in inductance. As will be described below, the inductance change feature ΔL can be easily calculated without using the magnetic flux Φ, unlike the inductance. Accordingly, in the embodiment, the inductance change feature ΔL is calculated by the inductance change detection unit 21 to detect a change in inductance.

As illustrated in FIG. 2, the three-phase AC currents Iu, Iv, and Iw and previous values Vu*_z, Vv*_z, and Vw*_z of the three-phase AC voltage command are input to the inductance change detection unit 21. The inductance change detection unit 21 calculates the inductance change feature ΔL using the formula V=ΔL×(dI/dt) for a phase having a largest absolute value of the current among the three-phase AC currents Iu, Iv, and Iw. V=ΔL×(dI/dt) can be derived using the above-described dΦ/dI=ΔL with respect to a formula V=dΦ/dt established between the voltage V applied to the coil and the magnetic flux Φ generated in the coil.

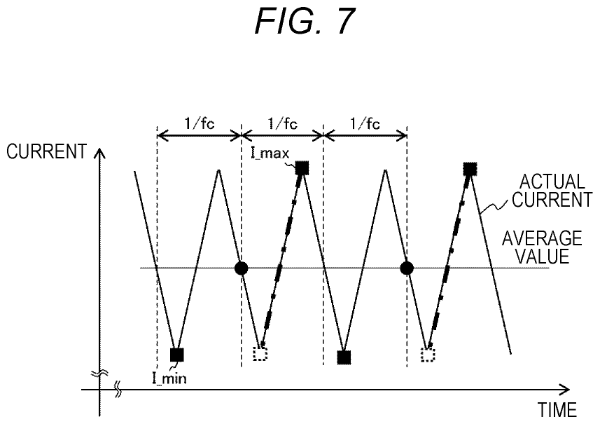

FIGS. 6 and 7 are diagrams illustrating a sampling period of a current used to calculate an inductance change feature. In FIGS. 6 and 7, the vertical axis represents a current, the horizontal axis represents time, and an example of a current waveform of one phase of the three-phase AC current is illustrated. As illustrated in FIG. 6, the inductance change detection unit 21 obtains dI/dt using a minimum value I_min and a maximum value I_max of the current indicated by a square plot in an actual current. Therefore, the inductance change detection unit 21 acquires the current value at a timing at which a current ripple becomes the minimum value and the maximum value. For example, as described above, when the average value (circle plot) of the current is acquired for each sampling period Ts, the inductance change detection unit 21 acquires a minimum value of the current ripple at a time of (4N+1)×Ts/4 (where N is an integer) and acquires a maximum value of the current ripple at a time of (4N+3)×Ts/4. In this case, a time interval between the minimum value I_min and the maximum value I_max of the current ripple acquired within the sampling period Ts of the average value of the current is about Ts/2. Accordingly, the inductance change detection unit 21 calculates dI/dt as (I_max−I_min)/(Ts/2). The inductance change detection unit 21 substitutes the calculated dI/dt and a previous value of the AC voltage command of the phase for which dI/dt has been calculated into V=ΔL×(dI/dt) to calculate the inductance change feature ΔL, and outputs the inductance change feature ΔL to the current phase angle control unit 22.

In the above description, the inductance change feature ΔL is calculated for a phase that has the largest absolute value of the current among the currents Iu, Iv, and Iw of each phase, but the present invention is not limited thereto. For example, the inductance change feature ΔL may be calculated for each phase regardless of magnitude of the absolute values of the currents Iu, Iv, and Iw of each phase, and the inductance change feature ΔL that is most deviated from L0 may be output to the current phase angle control unit 22.

When the carrier wave frequency fc is high, the inductance change detection unit 21 may alternately acquire the minimum value I_min of the current ripple and the maximum value I_max of the current ripple for each 1/fc, as illustrated in FIG. 7. In this case, the inductance change detection unit 21 calculates dI/dt by regarding the acquired minimum value I_min (filled square plot) of the current ripple as the minimum value (dotted square plot) of the current ripple of a next cycle.

As illustrated in FIG. 2, the current phase angle control unit 22 determines a current phase angle θcrr in accordance with the inductance change feature ΔL calculated by the inductance change detection unit 21. Here, the current phase angle θcrr is a leading phase angle from the q axis of a current vector determined by the three-phase AC currents Iu, Iv, and Iw. The current phase angle control unit 22 preferably acquires and stores in advance the current phase angle θcrr at which a loss is minimum for each inductance change feature ΔL. For example, the current phase angle θcrr at which the loss is minimum is acquired in advance for each inductance change feature ΔL by experiment, analysis, or the like. When features or the like of the motor are clear, the current phase angle θcrr at which the loss is minimum can be calculated for each inductance change feature ΔL based on the mathematical formula and acquired in advance. The current phase angle control unit 22 outputs the current phase angle θcrr corresponding to the input inductance change feature ΔL with reference to the current phase angle θcrr for each inductance change feature ΔL acquired in advance.

The carrier wave frequency switching unit 23 determines switching of the carrier wave frequency based on the current phase angle θcrr and the estimated rotational position de of the motor 2. Therefore, a direction of a current vector is obtained from the estimated rotational position de and the current phase angle θcrr of the motor 2, and a phase angle of the U-phase current, a phase angle of the V-phase current, and a phase angle of the W-phase current are obtained. The carrier wave frequency switching unit 23 outputs a switching flag FlgFrqSw based on the phase angle of the U-phase current, the phase angle of the V-phase current, and the phase angle of the W-phase current, as will be described below. For example, two types of frequencies of a high frequency and a low frequency are prepared as the carrier wave frequency. The switching flag FlgFrqSw is set to 1 when the carrier wave frequency is set to the high frequency. The switching flag FlgFrqSw is set to 0 when the carrier wave frequency is set to the low frequency. Details of an operation of the carrier wave frequency switching unit 23 will be described below.

The current command generation unit 10 calculates a d-axis current command Id* and a q-axis current command Iq*based on the input torque command T*, power supply voltage Hvdc, and current phase angle θcrr. Here, for example, the d-axis current command Id* and the q-axis current command Iq* in accordance with the torque command T*, the power supply voltage Hvdc, and the current phase angle θcrr are obtained using a preset current command map, a mathematical formula representing a relationship between the d-axis current Id and the q-axis current Iq, and the motor torque, or the like. After the d-axis current command Id* and the q-axis current command Iq* that satisfy a demand for the torque command T* and the power supply voltage Hvdc are obtained, a final d-axis current command Id* and q-axis current command Iq* can be obtained by correcting the d-axis current command Id* and the q-axis current command Iq* using the current phase angle θcrr.

The current conversion unit 12 performs dq conversion based on the rotational position Or obtained by the rotational position detector 4 on the three-phase AC currents Iu, Iv, and Iw detected by the current detection unit 7, and calculates a d-axis current value Id and a q-axis current value Iq.

Based on deviations between the d-axis current command Id* and the q-axis current command Iq* output from the current command generation unit 10 and the d-axis current value Id and the q-axis current value Iq output from the current conversion unit 12, the current control unit 13 calculates a d-axis voltage command Vd* and a q-axis voltage command Vq* in response to the torque command T* so that these values match each other. Here, for example, according to a control method such as PI control, the d-axis voltage command Vd* in accordance with the deviation between the d-axis current command Id* and the d-axis current value Id and the q-axis voltage command Vq* in accordance with the deviation between the q-axis current command Iq* and the q-axis current value Iq are obtained.

The three-phase voltage conversion unit 18 calculates and outputs the three-phase AC voltage commands Vu*, Vv*, and Vw* (a U-phase voltage command Vu*, a V-phase voltage command Vv*, and a W-phase voltage command Vw*) based on the d-axis current command Id* and the q-axis current command Iq* output from the current command generation unit 10 and the estimated rotational position de calculated by the phase calculation unit 16.

Using the carrier wave signal Sc output from the carrier wave generation unit 15, the gate signal generation unit 19 performs pulse width modulation on each of the three-phase AC voltage commands Vu*, Vv*, and Vw* output from the three-phase voltage conversion unit 18, and generates a gate signal for controlling the operation of the inverter 3. Specifically, a pulsed voltage is generated for each of the U phase, the V phase, and the W phase based on a comparison result between the three-phase AC voltage commands Vu*, Vv*, and Vw* output from the three-phase voltage conversion unit 18 and the carrier wave signal Sc output from the carrier wave generation unit 15. Then, a pulsed gate signal for the switching element of each phase of the inverter 3 is generated based on the generated pulsed voltage. At this time, gate signals Gup, Gvp, and Gwp of the upper arms of the phases are logically inverted to generate gate signals Gun, Gvn, and Gwn of the lower arms. The gate signal generated by the gate signal generation unit 19 is output from the motor control device 1 to the PWM signal drive circuit 32 of the inverter 3, and is converted into a PWM signal by the PWM signal drive circuit 32. Accordingly, each switching element of the inverter circuit 31 is controlled between ON and OFF, and the output voltage of the inverter 3 is adjusted.

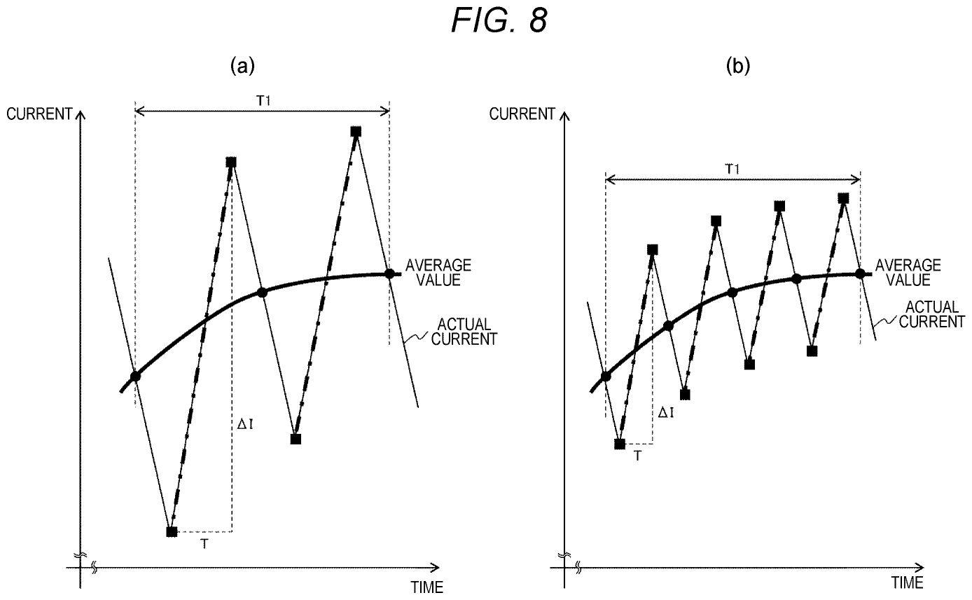

FIG. 8 is a diagram illustrating a relationship between a carrier wave frequency and a current ripple. The vertical axis represents a current, the horizontal axis represents time, and a portion of a current waveform corresponding to one phase of the three-phase AC current within a time width T1 is extracted. A carrier wave frequency of FIG. 8b is assumed to be higher than a carrier wave frequency of FIG. 8a. In FIG. 8a, a current ripple corresponding to two cycles are included in the time width T1. On the other hand, in FIG. 8b, a current ripple corresponding to four cycles is included in the same time width T1. The current ripple included in the same time width T1 is larger than that in FIG. 8b in which a carrier wave frequency is higher. Therefore, a current difference ΔI and a time width AT used for calculating dI/dt are smaller than those in FIG. 8b in which a carrier wave frequency is higher. When AI and AT decrease, accuracy of calculation of dI/dt also is improved. Therefore, dI/dt can be calculated with higher accuracy than that in FIG. 8b in which a carrier wave frequency is higher. Accordingly, accuracy of the inductance change feature ΔL calculated using dI/dt is also improved. Thus, the motor control device according to the embodiment raises the carrier wave frequency in a phase region where the inductance changes, that is, a phase region including a phase at which an absolute value of one of the three-phase AC currents is maximum. Accordingly, it is possible to accurately detect a change in inductance.

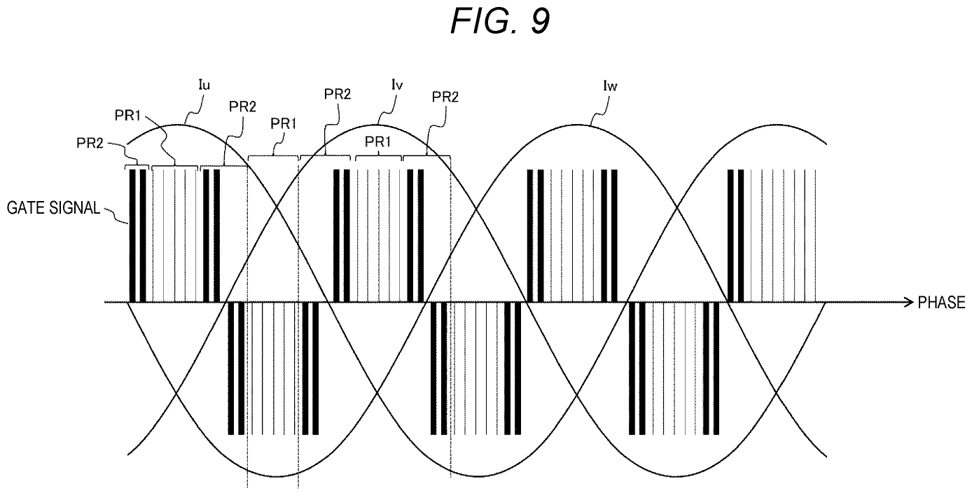

FIG. 9 is a diagram illustrating a relationship between a three-phase AC current and a carrier wave frequency. FIG. 9 is a diagram in which a gate signal is superimposed on a current waveform of a three-phase AC current, and the horizontal axis represents a phase. In FIG. 9, PR1 is a first phase region and PR2 is a second phase region. A line width of the gate signal indicates a level of the carrier wave frequency. The lower the carrier wave frequency is, the thicker the line width of the gate signal is. As illustrated in FIG. 9, the carrier wave frequency adjustment unit 14 raises the frequency of a carrier wave in the first phase region PR1 including a phase at which the absolute value of one of the three-phase AC currents is maximum. Within a range of one period (2π) of the phase of the three-phase AC current, there are three phases at which one of Iu, Iv, and Iw is maximum, and there are three phases at which one of Iu, Iv, and Iw is minimum. Therefore, the first phase region PR1 is set in advance to include six phases at which one of Iu, Iv, and Iw is maximum or minimum. FIG. 9 illustrates an example in which regions near six phases at which one of Iu, Iv, and Iw is maximum or minimum, that is, six regions where the line width of the gate signal is thin, are set as the first phase regions PR1, but the present invention is not limited thereto. When the phase of the three-phase AC current calculated based on the current phase angle θcrr and the estimated rotational position de of the motor 2 is within the first phase region PR1, the carrier wave frequency switching unit 23 sets the switching flag FlgFrqSw to 1. The carrier wave frequency adjustment unit 14 sets the frequency of the carrier wave to a high frequency when the switching flag FlgFrqSw is 1. In this way, the change in inductance can be accurately detected by raising the carrier wave frequency in the phase region where the change in inductance occurs.

As illustrated in FIG. 9, the carrier wave frequency adjustment unit 14 lowers the frequency of the carrier wave in the second phase region PR2 including the phase at which the absolute value of one of the three-phase AC currents becomes 0. There are six phases at which one of Iu, Iv, and Iw becomes 0 within a range of one period (2π) of the phase of the three-phase AC current. Therefore, the second phase region PR2 is set in advance to include six phases at which one of Iu, Iv, and Iw becomes 0. FIG. 9 illustrates an example in which regions near six phases at which one of Iu, Iv, and Iw is 0, that is, six regions where the line width of the gate signal is thick, are set as the second phase regions PR2, but the present invention is not limited thereto. When the phase of the three-phase AC current calculated based on the current phase angle θcrr and the estimated rotational position θe of the motor 2 is within the second phase region PR2, the carrier wave frequency switching unit 23 sets the switching flag FlgFrqSw to 0. Then, the carrier wave frequency adjustment unit 14 sets the frequency of the carrier wave to a low frequency when the switching flag FlgFrqSw is 0. As described above, the switching loss can be suppressed by lowering the carrier wave frequency in the phase region where the inductance is unlikely to change.

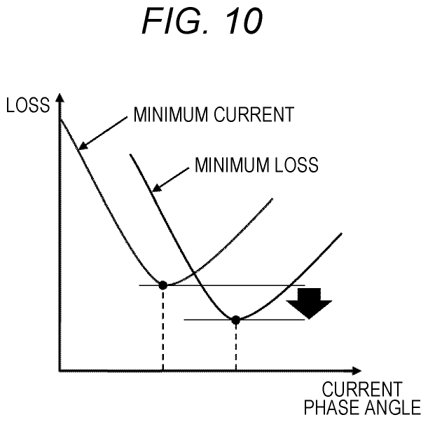

FIG. 10 is a diagram illustrating a relationship between a loss and a current phase angle. As illustrated in FIG. 10, a current phase angle at which the loss is minimum deviates from a current phase angle at which the current is minimum. In the present invention, the loss can be minimum by calculating the inductance change feature from the measured current value and controlling the current phase angle based on the calculated inductance change feature instead of controlling the current phase angle to minimize the current.

### REFERENCE SIGNS LIST

1 motor control device
2 motor
3 inverter
4 rotational position detector
5 high-voltage battery
7 current detection unit
8 rotational position sensor
10 current command generation unit
11 speed calculation unit
12 current conversion unit
13 current control unit
14 carrier wave frequency adjustment unit
15 carrier wave generation unit
16 phase calculation unit
18 three-phase voltage conversion unit
19 gate signal generation unit
21 inductance change detection unit
22 current phase angle control unit
23 carrier wave frequency switching unit
31 inverter circuit
32 PWM signal drive circuit
33 smoothing capacitor
34 voltage detection unit
100 motor drive system

1. A motor control device connected to a power converter that performs power conversion from DC power to three-phase AC power and drives a motor with the three-phase AC power to control the power conversion of the power converter, the motor control device comprising:
an inductance change detection unit configured to calculate an inductance change feature indicating a change in inductance of the motor in a first phase region including a phase at which an absolute value of one of three-phase AC currents is a maximum; and
a current phase angle control unit configured to control a current phase angle based on the inductance change feature.

2. The motor control device according to claim 1, further comprising:
a three-phase AC voltage command generation unit configured to generate a three-phase AC voltage command,
wherein the inductance change detection unit calculates the inductance change feature based on the three-phase AC voltage command and a three-phase AC current of the motor.

3. The motor control device according to claim 2,
wherein the inductance change detection unit calculates the inductance change feature from time differentiation of the three-phase AC current and the three-phase AC voltage command.

4. The motor control device according to claim 2, further comprising:
a gate signal generation unit configured to perform pulse width modulation on the three-phase AC voltage command and generate a gate signal for controlling the power conversion of the power converter; and
a carrier wave frequency adjustment unit configured to adjust a frequency of a carrier wave used for the pulse width modulation based on the current phase angle and a rotational position of the motor,
wherein the carrier wave frequency adjustment unit sets the frequency of the carrier wave to be higher than the frequency of the carrier wave in a second phase region including a phase at which an absolute value of one of the three-phase AC currents becomes zero in the first phase region.

5. A power conversion system comprising:
the motor control device according to claim 1; and
the power converter.
